(19) United States
(12) Patent Application Publication
(10) Pub. No.: US 2022/0282393 A1
(43) Pub. Date: Sep. 8, 2022

(54) DEVICE AND METHOD FOR PREVENTING BATH CRYSTALLIZATION OF SQUEEZING COMPONENT OF ELECTROPLATING EQUIPMENT

(71) Applicant: Chongqing JIMAT New Material Technology Co., Ltd., Chongqing (CN)

(72) Inventors: Shiwei ZANG, Chongqing (CN); Wenqing LIU, Chongqing (CN)

(21) Appl. No.: 17/752,153

(22) Filed: May 24, 2022

Related U.S. Application Data
(63) Continuation of application No. PCT/CN2021/099472, filed on Jun. 10, 2021.

(30) Foreign Application Priority Data
Dec. 24, 2020 (CN) 202011548279.9

(51) Int. Cl. C25D 17/02; C25D 21/12

(52) U.S. Cl. CPC C25D 17/02; C25D 21/12

(57) ABSTRACT

The present invention discloses a device and method for preventing bath crystallization of a squeezing component of electroplating equipment in the technical field of manufacturing of copper electroplating films. The device comprises a plating tank and a squeezing component located on the discharge end of the plating tank. A non-metallic film is squeezed by the squeezing component after being discharged from the plating tank. A wind cutting device is arranged between the plating tank and the squeezing component for wind cutting of the discharged non-metallic film; and a spraying component is arranged behind the squeezing component for spraying the squeezing component. The method comprises a step of adding a wind cutting device for wind cutting of a non-metallic film to remove bath and a step of adding a spraying component for spraying the squeezing component. In the present invention, the wind cutting device and the spraying component are added specifically to eliminate bath crystallization so as to avoid piercing or concave and convex points of non-metallic films caused by crystallization and fully improve the quality of the plating product.

### TECHNICAL FIELD

The present invention relates to the technical field of manufacturing of copper electroplating films, and particularly relates to a device and method for preventing bath crystallization of a squeezing component of electroplating equipment.

### BACKGROUND

During the process of copper film electroplating, a non-metallic film will have a certain amount of bath on the surfaces thereof when being discharged from a plating tank. To prevent the influence on the subsequent procedures, the discharge end of the planting tank is provided with a squeezing component for squeezing the non-metallic film, and the squeezing component generally comprises a conductor roll and a squeezing roll which are mated with each other for squeezing. When the non-metallic film passes through the squeezing component, the bath on the surfaces of the film will remain on the conductor roll and the squeezing roll. After a long time, the bath remaining on the conductor roll and the squeezing roll will crystallize to form particles or spines. When other non-metallic film pass through the squeezing component in future, the particles or spines will pierce the non-metallic films or form concave and convex points on the surfaces of the non-metallic films, which has serious influence on the quality of the film surfaces.

To prevent such conditions, the existing electroplating equipment is provided with scrapers on each roll structure, and copper on the surfaces of rolls is removed by the scrapers, but the addition of such structures will greatly increase the production cost of the whole electroplating equipment due to the large number of rolls in the electroplating equipment. In addition, irregular scrapers may also scratch the surfaces of the rolls, having an adverse effect.

The above defects are worth solving.

### SUMMARY

To overcome the defects in the prior art, the present invention provides a device and method for preventing bath crystallization of a squeezing component of electroplating equipment.

The present invention has the following technical solution:

In one aspect, a device for preventing bath crystallization of a squeezing component of electroplating equipment, comprising a plating tank and a squeezing component located on the discharge end of the plating tank, wherein a non-metallic film is squeezed by the squeezing component after being discharged from the plating tank, and a wind cutting device is arranged between the plating tank and the squeezing component for wind cutting of the discharged non-metallic film; and a spraying component is arranged behind the squeezing component for spraying the squeezing component.

The present invention according to the above solution, wherein the wind cutting device comprises an upper wind cutting unit and a lower wind cutting unit, the upper wind cutting unit is located above the non-metallic film, and the lower wind cutting unit is located below the non-metallic film.

Further, the wind outlet of the upper wind cutting unit and the wind outlet of the lower wind cutting unit both face to the discharging position for the non-metallic film.

The present invention according to the above solution, wherein the spraying component comprises an upper spraying pipe and a lower spraying pipe, the upper spraying pipe is located above the non-metallic film, and the lower spraying pipe is located below the non-metallic film.

The present invention according to the above solution, wherein a collecting tank is arranged below the spraying component, and the edge of the collecting tank is located on the outer side of the squeezing component.

The present invention according to the above solution, wherein a second wind cutting device is arranged behind the spraying component, and the second wind cutting device is used for wind cutting of the sprayed non-metallic film.

Further, an auxiliary squeezing component is arranged between the spraying component and the second wind cutting device for squeezing the sprayed non-metallic film.

In another aspect, a method for preventing bath crystallization of a squeezing component of electroplating equipment, wherein a wind cutting device is added on the discharge end for a non-metallic film, and wind cutting of the non-metallic film with bath is carried out by the wind cutting device to remove bath on the film surfaces; and a spraying component is added behind the squeezing component, and the squeezing component is sprayed by the squeezing component to prevent bath crystallization.

The present invention according to the above solution, comprising the following specific steps:

S1: discharging a non-metallic film;

S2: carrying out wind cutting of the discharged non-metallic film by the wind cutting device to remove bath on the film surfaces;

S3: squeezing the non-metallic film by the squeezing component;

S4: spraying the squeezing component by the spraying component to prevent crystallization on the surface;

S5: letting the non-metallic film pass through a tension roll before entering other process equipment.

Further, after step S4, the present invention also comprises:

A1: squeezing the non-metallic film by the auxiliary squeezing component;

A2: carrying out wind cutting of the sprayed and squeezed non-metallic film by the second wind cutting device to remove sprayed fluid on the film surfaces.

The present invention according to the above solution has the following beneficial effects: the present invention fully reduces the bath brought by the non-metallic film from the plating tank to reduce the influence on the squeezing component by adding the wind cutting device between the plating tank and the squeezing component, and dilutes and cleans the squeezing component by the spraying component added behind the squeezing component to prevent bath crystallization on the squeezing component, so as to ensure that a little or even no bath remains on the squeezing component and eliminate bath crystallization, thus avoiding piercing or concave and convex points of non-metallic films caused by crystallization and fully improve the quality of the plating product. In addition, the present invention minimizes the product volume of electroplating equipment and the production cost by specifically adding mechanisms.

### DESCRIPTION OF DRAWINGS

FIG. 1 is a structural schematic diagram of the present invention;

FIG. 2 is a flow diagram for implementation of an embodiment of the present invention;

FIG. 3 is a flow diagram for implementation of another embodiment of the present invention;

In the figures, 10—plating tank; 11—bath; 20—non-metallic film; 30—first wind cutting device; 41—first conductor roll; 42—first squeezing roll; 50—spraying component; 61—second conductor roll; 62—second squeezing roll; 70—second wind cutting device; 80—tension roll; 90—collecting tank.

### DETAILED DESCRIPTION

The present invention is further described below in combination with the drawings and embodiments.

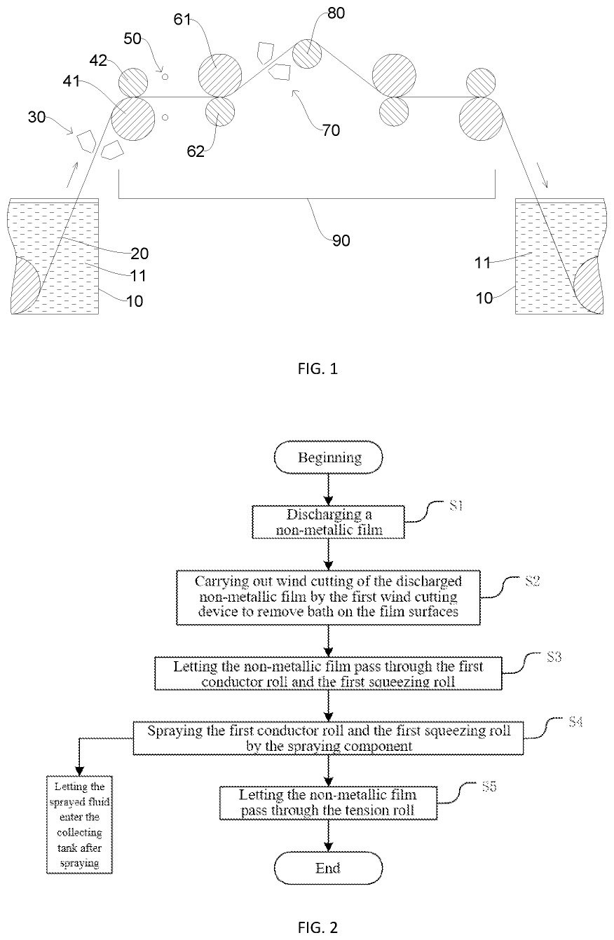

A shown in FIG. 1, a device for preventing bath crystallization of a squeezing component of electroplating equipment, comprises a plating tank 10 and a squeezing component located on the discharge end of the plating tank 10. A non-metallic film 20 is squeezed by the squeezing component after being discharged out of bath 11 in the plating tank 10. In the present invention, a wind cutting device (i.e., a first wind cutting device 30) is arranged between the plating tank 10 and the squeezing component for wind cutting of the discharged non-metallic film 20; and a spraying component 50 is arranged behind the squeezing component for spraying the squeezing component.

The first wind cutting device 30 comprises a first upper wind cutting unit and a first lower wind cutting unit, the first upper wind cutting unit is located above the non-metallic film 20 for removing bath 11 on the upper side of the non-metallic film 20 by wind cutting, and the first lower wind cutting unit is located below the non-metallic film 20 for removing bath 11 on the lower side of the non-metallic film 20 by wind cutting. The present invention can remove most of bath 11 on the surfaces of the non-metallic film 20 brought from the plating tank 10 through the application of the first wind cutting device 30.

Preferably, the wind outlet of the upper wind cutting unit and the wind outlet of the lower wind cutting unit both face to the discharging position for the non-metallic film 20 to enable the upper wind cutting unit to blow the bath on the upper surface of the non-metallic film to the plating tank 10 and the lower wind cutting unit to blow the bath on the lower surface of the non-metallic film to the plating tank 10 so that most of the bath on the surfaces of the non-metallic film 20 falls back into the plating tank 10 to reduce corrosion to the external structure,

The squeezing component comprises a first conductor roll 41 and a first squeezing roll 42, wherein the first conductor roll 41 is located below the first squeezing roll 42, and the non-metallic film 20 is squeezed by mutual extrusion of the first squeezing roll 42 and the first conductor roll 41. The spraying component 50 comprises an upper spraying pipe and a lower spraying pipe, the upper spraying pipe is located above the non-metallic film 20, the outlet of the upper spraying pipe faces to the first squeezing roll 42, the lower spraying pipe is located below the non-metallic film 20, and the outlet of the lower spraying pipe faces to the first conductor roll 41.

The upper spraying pipe and the lower spraying pipe in the embodiment are made of PVC (polyvinyl chloride) materials, and can be made of other acid and alkali corrosion resistant materials besides PVC in other embodiments.

Preferably, the spraying component of the embodiment sprays the first conductor roll 41 and the first squeezing roll 42 with pure water to dilute the bath remaining on the surfaces of the first conductor roll 41 and the first squeezing roll 42 so as to prevent crystallization on the surfaces of the first conductor roll 41 and the first squeezing roll 42. In other embodiments, other special cleaning fluids that do not affect the composition of the bath can also be used.

In the present invention, a collecting tank 90 is arranged below the spraying component 50, the edge of the collecting tank 90 is located on the outer side of the squeezing component, and the sprayed fluid is collected and drained out through the collecting tank 90 to avoid the damage and destruction to other parts of the equipment caused by the sprayed fluid.

To prevent the sprayed fluid from diluting bath 11 in the plating tank 10 when the sprayed non-metallic film 20 enters other plating tanks, a second wind cutting device 70 is arranged behind the spraying component 50, the second wind cutting device 70 is used for wind cutting of the sprayed non-metallic film 20, and an auxiliary squeezing component is arranged between the spraying component 50 and the second wind cutting device 70 for squeezing the sprayed non-metallic film 20. With the similar structure to the first wind cutting device 30, the second wind cutting device 70 comprises a second upper wind cutting unit and a second lower wind cutting unit, the second upper wind cutting unit is located above the non-metallic film 20 for wind cutting of fluid on the upper surface of the non-metallic film 20, and the second lower wind cutting unit is located below the non-metallic film 20 for wind cutting of fluid on the lower surface of the non-metallic film.

Specifically, the auxiliary squeezing component comprises a second conductor roll 61 and a second squeezing roll 62, wherein the second conductor roll 61 is located above the second squeezing roll 62, and the passing non-metallic film 20 is squeezed by mutual extrusion of the second squeezing roll 62 and the second conductor roll 61.

Preferably, the film outlet end of the squeezing component and the film inlet end of the auxiliary squeezing component are located in the same horizontal plane so that the non-metallic film 20 between the squeezing component and the auxiliary squeezing component moves forward in the horizontal direction, i.e., the squeezing position between the first squeezing roll 42 and the first conductor roll 41 and the squeezing position between the second squeezing roll 62 and the second conductor roll 61 are located in the same horizontal plane, which enables the spraying component to realize good spray effects on the first conductor roll 41 and the first squeezing roll 42.

A tension roll 80 is arranged behind the second wind cutting device 70, and the non-metallic film 20 is stretched through the tension roll 80 to avoid wrinkles of the non-metallic film 20. Preferably, the tension roll 80 is higher than the film outlet end of the auxiliary squeezing component (i.e., the squeezing position between the second squeezing roll 62 and the second conductor roll 61) so that the non-metallic film 20 between the auxiliary squeezing component and the tension roll 80 is in the rising state, and correspondingly, the wind outlet of the second wind cutting device 70 faces to the squeezing component and to the lower side.

In the above embodiment, the collecting tank 90 is located below each roll and each device, specifically, the collecting tank 90 is located below the squeezing component, the spraying component 50, the auxiliary squeezing component, the second wind cutting device 70 and the tension roll 80 so that fluids falling in each link can be recycled.

The first wind cutting device 30 and the second wind cutting device 70 are made of stainless steel materials, and can be made of other acid and alkali corrosion resistant materials besides stainless steel in other embodiments.

In the implementation process of the present invention: firstly, a first wind cutting device 30 is arranged between the plating tank 10 and the squeezing component, and bath 11 on the upper and lower surfaces of the non-metallic film 20 brought from the plating tank 10 is removed by the first wind cutting device 30 to reduce the possibility of bringing bath into the first conductor roll 41 and the first squeezing roll 42; secondly, a spraying component 50 is arranged behind the squeezing component, and the fluid (preferably, atomized pure water) from the spraying component 50 reaches the surfaces of the first conductor roll 41 and the first squeezing roll 42 to dilute and clean bath on the rolls; thirdly, an auxiliary squeezing component is arranged behind the squeezing component for squeezing the sprayed non-metallic film 20, and a second wind cutting device 70 is arranged behind the auxiliary squeezing component for removing fluid on the surfaces of the non-metallic film 20 caused by spraying to prevent the sprayed fluid from being brought into the next plating tank 10 or other devices; and finally, the sprayed fluid and the fluid blown down by the second wind cutting device 70 can be collected and drained out through the collecting tank 90 below.

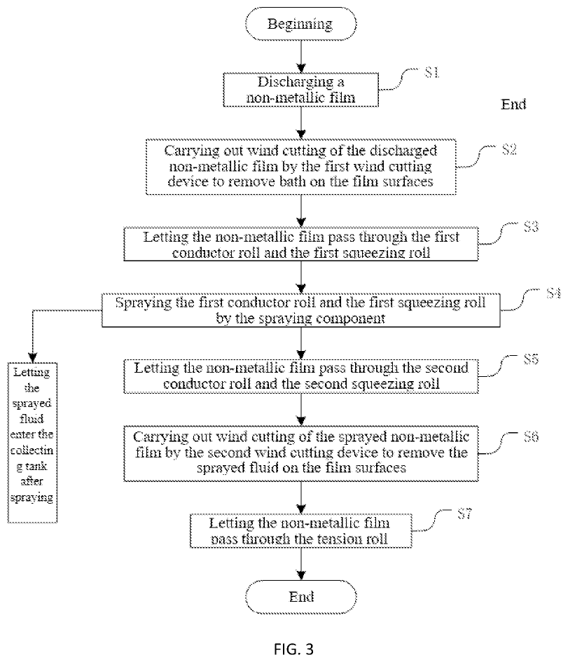

As shown in FIG. 2 and FIG. 3, a method for preventing bath crystallization of a squeezing component of electroplating equipment, wherein a wind cutting device is added on the discharge end for a non-metallic film, and wind cutting of the non-metallic film with bath is carried out by the wind cutting device to remove bath on the film surfaces; and a spraying component is added behind the squeezing component, and the squeezing component is sprayed by the squeezing component to prevent bath crystallization.

As shown in FIG. 2, in one embodiment, the method for preventing bath crystallization of a squeezing component of electroplating equipment comprises the following specific steps:

S1: discharging a non-metallic film;

S2: carrying out wind cutting of the discharged non-metallic film by the first wind cutting device to remove bath on the film surfaces;

S3: squeezing the non-metallic film by the squeezing component (the first conductor roll and the first squeezing roll);

S4: spraying the squeezing component (the first conductor roll and the first squeezing roll) by the spraying component to prevent crystallization on the surface, and collecting the sprayed fluid into the collecting tank;

S5: letting the non-metallic film pass through a tension roll before entering other process equipment.

As shown in FIG. 3, in another embodiment, the method for preventing bath crystallization of a squeezing component of electroplating equipment comprises the following specific steps:

S1: discharging a non-metallic film;

S2: carrying out wind cutting of the discharged non-metallic film by the first wind cutting device to remove bath on the film surfaces;

S3: squeezing the non-metallic film by the squeezing component (the first conductor roll and the first squeezing roll);

S4: spraying the squeezing component (the first conductor roll and the first squeezing roll) by the spraying component to prevent crystallization on the surface, and collecting the sprayed fluid into the collecting tank;

S5: squeezing the non-metallic film by the auxiliary squeezing component (the second conductor roll and the second squeezing roll);

S6: carrying out wind cutting of the non-metallic film passing through the auxiliary squeezing component (the second conductor roll and the second squeezing roll) by the second wind cutting device to remove the sprayed fluid on the film surfaces so as to avoid the influence of the sprayed fluid on the subsequent procedures.

S7: letting the non-metallic film pass through a tension roll before entering other process equipment.

The present invention reduces bath brought from the plating tank by adding the first wind cutting device among the plating tank, the first conductor roll and the first squeezing roll and adding the spraying component behind the first conductor roll and the first squeezing roll, and dilutes and cleans the first conductor roll and the first squeezing roll through spraying operation, which ensures that a little or even no bath remains on the first conductor roll and the first squeezing roll and eliminates bath crystallization so as to reduce concave and convex points on the film surfaces and improve the quality of the plating product.

It should be understood that, for those ordinary skilled in the art, improvements and alternations can be made according to the above description, and all these improvements and alternations shall belong to the protection scope of appended claims of the present invention.

The patent of present invention is exemplarily described above in combination with the drawings. Obviously, the implementation of the patent of the present invention is not limited by the above modes. Various improvements made by adopting the method ideas and technical solutions of the patent of the present invention or the ideas and technical solutions of the patent of the present invention directly applied to other occasions without improvements shall be within the protection scope of the present invention.

The present invention fully reduces the bath brought by the non-metallic film from the plating tank to reduce the influence on the squeezing component by adding the wind cutting device between the plating tank and the squeezing component, and dilutes and cleans the squeezing component by the spraying component added behind the squeezing component to prevent bath crystallization on the squeezing component, so as to ensure that a little or even no bath remains on the squeezing component and eliminate bath crystallization, thus avoiding piercing or concave and convex points of non-metallic films caused by crystallization and fully improve the quality of the plating product, and therefore, the device and method for preventing bath crystallization of a squeezing component of electroplating equipment of the present invention have practicality.

We claim:

1. A device for preventing bath crystallization of a squeezing component of electroplating equipment, comprising a plating tank and a squeezing component located on the discharge end of the plating tank, wherein a non-metallic film is squeezed by the squeezing component after being discharged from the plating tank, and a wind cutting device is arranged between the plating tank and the squeezing component for wind cutting of the discharged non-metallic film; and a spraying component is arranged behind the squeezing component for spraying the squeezing component.

2. The device for preventing bath crystallization of a squeezing component of electroplating equipment according to claim 1, wherein the wind cutting device comprises an upper wind cutting unit and a lower wind cutting unit, the upper wind cutting unit is located above the non-metallic film, and the lower wind cutting unit is located below the non-metallic film.

3. The device for preventing bath crystallization of a squeezing component of electroplating equipment according to claim 2, wherein the wind outlet of the upper wind cutting unit and the wind outlet of the lower wind cutting unit both face to the discharging position for the non-metallic film.

4. The device for preventing bath crystallization of a squeezing component of electroplating equipment according to claim 1, wherein the spraying component comprises an upper spraying pipe and a lower spraying pipe, the upper spraying pipe is located above the non-metallic film, and the lower spraying pipe is located below the non-metallic film.

5. The device for preventing bath crystallization of a squeezing component of electroplating equipment according to claim 1, wherein a collecting tank is arranged below the spraying component, and the edge of the collecting tank is located on the outer side of the squeezing component.

6. The device for preventing bath crystallization of a squeezing component of electroplating equipment according to claim 1, wherein a second wind cutting device is arranged behind the spraying component, and the second wind cutting device is used for wind cutting of the sprayed non-metallic film.

7. The device for preventing bath crystallization of a squeezing component of electroplating equipment according to claim 6, wherein an auxiliary squeezing component is arranged between the spraying component and the second wind cutting device for squeezing the sprayed non-metallic film.

8. A method for preventing bath crystallization of a squeezing component of electroplating equipment, wherein a wind cutting device is added on the discharge end for a non-metallic film, and wind cutting of the non-metallic film with bath is carried out by the wind cutting device to remove bath on the film surfaces;
a spraying component is added behind the squeezing component, and the squeezing component is sprayed by the squeezing component to prevent bath crystallization.

9. The method for preventing bath crystallization of a squeezing component of electroplating equipment according to claim 8, comprising the following specific steps:
S1: discharging a non-metallic film;
S2: carrying out wind cutting of the discharged non-metallic film by the wind cutting device to remove bath on the film surfaces;
S3: squeezing the non-metallic film by the squeezing component;
S4: spraying the squeezing component by the spraying component to prevent crystallization on the surface;
S5: letting the non-metallic film pass through a tension roll before entering other process equipment.

10. The method for preventing bath crystallization of a squeezing component of electroplating equipment according to claim 9, further comprising the following steps after step S4:
A1: squeezing the non-metallic film by the auxiliary squeezing component;
A2: carrying out wind cutting of the sprayed and squeezed non-metallic film by the second wind cutting device to remove sprayed fluid on the film surfaces.
